(19) United States
(12) Patent Application Publication
(10) Pub. No.: US 2012/0303539 A1
(43) Pub. Date: Nov. 29, 2012

(54) CUSTOMER CONTROLLED MANAGEMENT OF SHIPMENTS

(75) Inventors: Stuart Marcus, Atlanta, GA (US); Russell Bowling, Cumming, GA (US); John Slayton, Atlanta, GA (US); Randy Campbell, Woodstock, GA (US)

(73) Assignee: United Parcel Service of America, Inc.

(21) Appl. No.: 13/174,269

(22) Filed: Jun. 30, 2011

Related U.S. Application Data
(60) Provisional application No. 61/489,830, filed on May 25, 2011.

(51) Int. Cl. G06Q 30/00

(52) U.S. Cl. 705/330

(57) ABSTRACT

Systems, methods, apparatus, and computer program products are provided for customer controlled management of shipments. For example, in various embodiments, a customer can provide information prior to a first delivery attempt of an item by a carrier to receive messages regarding shipment of the item and to have the item delivered in accordance with the provided information.

### CROSS-REFERENCE TO RELATED APPLICATIONS

This application claims priority to U.S. Patent Application Ser. No. 61/489,830, filed on May 25, 2011, which is hereby incorporated herein in its entirety by reference.

### BACKGROUND

Shipping customers are increasing their expectations regarding various delivery services. Thus, new concepts are needed to enhance customer experience and loyalty by improving the delivery experience.

### BRIEF SUMMARY

In general, embodiments of the present invention provide systems, methods, apparatus, and computer program products for customer controlled management of shipments.

In accordance with one aspect, a method for providing information regarding the delivery of at least one item to a customer is provided. In one embodiment, the method comprises storing communication preferences for providing information to a customer regarding an item to be delivered to the customer, wherein the communication preferences (1) identify at least one communication format and at least one corresponding electronic destination address to be used in providing the information to the customer, and (2) define a time period prior to a first delivery attempt of the item in which a message providing the information is to be transmitted to the at least one corresponding electronic destination address; automatically generating a message providing the information regarding the item to be delivered to the customer; and automatically transmitting the message to the at least one corresponding electronic destination address within the defined time period prior to the first delivery attempt of the item to the customer.

In accordance with another aspect, a computer program product for providing information regarding the delivery of at least one item to a customer is provided. The computer program product may comprise at least one computer-readable storage medium having computer-readable program code portions stored therein, the computer-readable program code portions comprising executable portions configured to store communication preferences for providing information to a customer regarding an item to be delivered to the customer, wherein the communication preferences (1) identify at least one communication format and at least one corresponding electronic destination address to be used in providing the information to the customer, and (2) define a time period prior to a first delivery attempt of the item in which a message providing the information is to be transmitted to the at least one corresponding electronic destination address; automatically generate a message providing the information regarding the item to be delivered to the customer; and automatically transmit the message to the at least one corresponding electronic destination address within the defined time period prior to the first delivery attempt of the item to the customer.

In accordance with yet another aspect, an apparatus comprising at least one processor and at least one memory including computer program code is provided. In one embodiment, the at least one memory and the computer program code may be configured to, with the processor, cause the apparatus to at least store communication preferences for providing information to a customer regarding an item to be delivered to the customer, wherein the communication preferences (1) identify at least one communication format and at least one corresponding electronic destination address to be used in providing the information to the customer, and (2) define a time period prior to a first delivery attempt of the item in which a message providing the information is to be transmitted to the at least one corresponding electronic destination address; automatically generate a message providing the information regarding the item to be delivered to the customer; and automatically transmit the message to the at least one corresponding electronic destination address within the defined time period prior to the first delivery attempt of the item to the customer.

In accordance with another aspect, a method for receiving authorization to deliver at least one item is provided. In one embodiment, the method comprises receiving shipping data corresponding to an item to be delivered to a customer by a carrier, wherein the shipping data indicates that an in-person signature from the customer is requested for delivery of the item; and receiving authorization from the customer to deliver the item without an in-person signature from the customer, wherein the authorization is received (1) after shipment of the item has begun and (2) prior to a first delivery attempt of the item.

In accordance with still another aspect, a computer program product for receiving authorization to deliver at least one item is provided. The computer program product may comprise at least one computer-readable storage medium having computer-readable program code portions stored therein, the computer-readable program code portions comprising executable portions configured to receive shipping data corresponding to an item to be delivered to a customer by a carrier, wherein the shipping data indicates that an in-person signature from the customer is requested for delivery of the item; and receive authorization from the customer to deliver the item without an in-person signature from the customer, wherein the authorization is received (1) after shipment of the item has begun and (2) prior to a first delivery attempt of the item.

In accordance with yet another aspect, an apparatus comprising at least one processor and at least one memory including computer program code is provided. In one embodiment, the at least one memory and the computer program code may be configured to, with the processor, cause the apparatus to at least receive shipping data corresponding to an item to be delivered to a customer by a carrier, wherein the shipping data indicates that an in-person signature from the customer is requested for delivery of the item; and receive authorization from the customer to deliver the item without an in-person signature from the customer, wherein the authorization is received (1) after shipment of the item has begun and (2) prior to a first delivery attempt of the item.

In accordance with another aspect, a method for identifying a customer profile corresponding to at least one item to be delivered by a carrier is provided. In one embodiment, the method comprises storing a plurality of customer profiles corresponding respectively to a plurality of customers, wherein each customer profile comprises at least one delivery address; receiving shipping data corresponding to an item to be delivered by a carrier, wherein the shipping data comprises a delivery address for the item; identifying a delivery address of a first customer profile from the plurality of customer profiles that is substantially similar to the delivery address for the item; and after identifying the delivery address of the first customer profile from the plurality of customer profiles that is substantially similar to the delivery address for the item, associating the shipping data corresponding to the item with the first customer profile.

In accordance with yet another aspect, a computer program product for identifying a customer profile corresponding to at least one item to be delivered by a carrier is provided. The computer program product may comprise at least one computer-readable storage medium having computer-readable program code portions stored therein, the computer-readable program code portions comprising executable portions configured to store a plurality of customer profiles corresponding respectively to a plurality of customers, wherein each customer profile comprises at least one delivery address; receive shipping data corresponding to an item to be delivered by a carrier, wherein the shipping data comprises a delivery address for the item; identify a delivery address of a first customer profile from the plurality of customer profiles that is substantially similar to the delivery address for the item; and after identifying the delivery address of the first customer profile from the plurality of customer profiles that is substantially similar to the delivery address for the item, associate the shipping data corresponding to the item with the first customer profile.

In accordance with another aspect, an apparatus comprising at least one processor and at least one memory including computer program code is provided. In one embodiment, the at least one memory and the computer program code may be configured to, with the processor, cause the apparatus to at least store a plurality of customer profiles corresponding respectively to a plurality of customers, wherein each customer profile comprises at least one delivery address; receive shipping data corresponding to an item to be delivered by a carrier, wherein the shipping data comprises a delivery address for the item; identify a delivery address of a first customer profile from the plurality of customer profiles that is substantially similar to the delivery address for the item; and after identifying the delivery address of the first customer profile from the plurality of customer profiles that is substantially similar to the delivery address for the item, associate the shipping data corresponding to the item with the first customer profile.

In accordance with another aspect, a method for changing delivery options for at least one item to be delivered by a carrier is provided. In one embodiment, the method comprises storing shipping data corresponding to an item to be delivered to a customer by a carrier; causing display of at least a portion of the shipping data corresponding to the item to be delivered to the customer; receiving a request to change at least one delivery option for the item, wherein (1) the at least one delivery option is selected from the group consisting of an expected delivery date, a delivery location, and a delivery time, and (2) the request to change the at least one delivery option is received prior to a first delivery attempt of the item; accepting the request to change the at least one delivery option for the item; and updating the shipping data to reflect acceptance of the request to change the at least one delivery option, wherein the item is subsequently delivered in accordance with the at least one delivery option.

In accordance with yet another aspect, a computer program product for changing delivery options for at least one item to be delivered by a carrier is provided. The computer program product may comprise at least one computer-readable storage medium having computer-readable program code portions stored therein, the computer-readable program code portions comprising executable portions configured to store shipping data corresponding to an item to be delivered to a customer by a carrier; cause display of at least a portion of the shipping data corresponding to the item to be delivered to the customer; receive a request to change at least one delivery option for the item, wherein (1) the at least one delivery option is selected from the group consisting of an expected delivery date, a delivery location, and a delivery time, and (2) the request to change the at least one delivery option is received prior to a first delivery attempt of the item; accept the request to change the at least one delivery option for the item; and update the shipping data to reflect acceptance of the request to change the at least one delivery option, wherein the item is subsequently delivered in accordance with the at least one delivery option.

In accordance with yet another aspect, an apparatus comprising at least one processor and at least one memory including computer program code is provided. In one embodiment, the at least one memory and the computer program code may be configured to, with the processor, cause the apparatus to at least store shipping data corresponding to an item to be delivered to a customer by a carrier; cause display of at least a portion of the shipping data corresponding to the item to be delivered to the customer; receive a request to change at least one delivery option for the item, wherein (1) the at least one delivery option is selected from the group consisting of an expected delivery date, a delivery location, and a delivery time, and (2) the request to change the at least one delivery option is received prior to a first delivery attempt of the item; accept the request to change the at least one delivery option for the item; and update the shipping data to reflect acceptance of the request to change the at least one delivery option, wherein the item is subsequently delivered in accordance with the at least one delivery option.

In accordance with still another aspect, a method for providing at least one instruction for delivering at least one item to a customer by a carrier is provided. In one embodiment, the method comprises storing shipping data corresponding to an item to be delivered to a customer by a carrier; receiving at least one instruction for delivering the item, wherein the at least one instruction (1) was provided by the customer and (2) is received prior to a first delivery attempt of the item; updating the shipping data to reflect the at least one instruction; and transmitting at least a portion of the updated shipping data corresponding to the item, the updated shipping data comprising the at least one instruction; and receiving at least a portion of the updated shipping data corresponding to the item, wherein (1) the mobile station is operated by a delivery person of the carrier, and (2) the item is subsequently delivered by the delivery person in accordance with the at least one instruction.

In accordance with yet another aspect, a system for providing at least one instruction for delivering at least one item to a customer is provided. The system may comprise (1) a carrier system comprising one or more processors and one or more memory storage areas and (2) a mobile station comprising one or more processors and one or more memory storage areas. In one embodiment, the carrier system may be configured to store shipping data corresponding to an item to be delivered to a customer by a carrier, receive at least one instruction for delivering the item, wherein the at least one instruction (1) was provided by the customer and (2) is received prior to a first delivery attempt of the item, update the shipping data to reflect the at least one instruction, and transmit at least a portion of the updated shipping data corresponding to the item, the updated shipping data comprising the at least one instruction. The mobile station may be configured to receive at least a portion of the updated shipping data corresponding to the item, and wherein (1) the mobile station is operated by a delivery person of the carrier, and (2) the item is subsequently delivered by the delivery person in accordance with the at least one instruction.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier system according to one embodiment of the present invention.

FIG. 3 is an exemplary schematic diagram of a mobile station according to one embodiment of the present invention.

FIG. 4 is a flowchart illustrating operations and processes that can be used in accordance with various embodiments of the present invention.

FIGS. 5-26 show exemplary input and output of various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. METHODS, APPARATUS, SYSTEMS, AND COMPUTER PROGRAM PRODUCTS

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. EXEMPLARY SYSTEM ARCHITECTURE

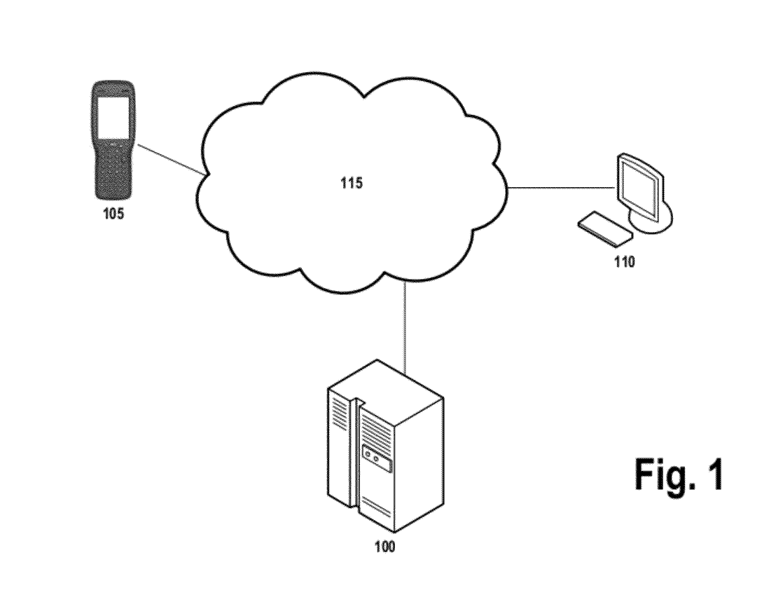

FIG. 1 provides an illustration of a system that can be used in conjunction with various embodiments of the present invention. As shown in FIG. 1, the system may include one or more carrier systems 100, one or more mobile stations 105, one or more customer computing devices 110, and one or more networks 115. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain communication system entities as separate, standalone entities, the various embodiments are not limited to this particular architecture.

### 1. Exemplary Carrier System

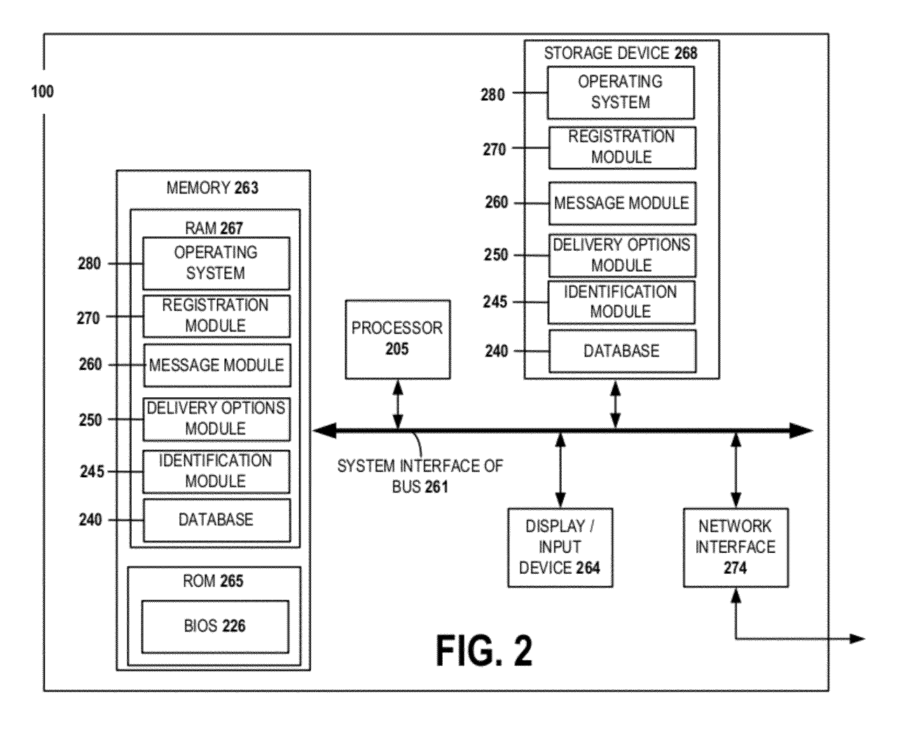

FIG. 2 provides an exemplary schematic of a carrier system 100 according to one embodiment of the present invention. In general, the term “system” may refer to, for example, one or more computers, computing devices, mobile phones, desktops, notebooks or laptops, distributed systems, servers, blades, gateways, switches, processing devices, or combination of processing devices adapted to perform the functions described herein. However, the carrier system 100 may also comprise various other systems, such as an Address Matching System (AMS), an Internet Membership System (IMS), a Customer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and their corresponding components.

As will be understood from FIG. 1, in one embodiment, the carrier system 100 includes one or more processor 205 that communicates with other elements within the carrier system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the carrier system 100. This display device/input device 264 may be, for example, a keyboard or pointing device that is used in combination with a monitor. The carrier system 100 may further include transitory and non-transitory memory 263, which may include both random access memory (RAM) 267 and read only memory (ROM) 265. The carrier system's ROM 265 may be used to store a basic input/output system (BIOS) 226 containing the basic routines that help to transfer information to the different elements within the carrier system 100.

In addition, in one embodiment, the carrier system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, or the like. Additionally, each of these storage devices 268 may be connected to the system bus 261 by an appropriate interface.

Furthermore, a number of executable instructions, applications, program modules, and/or the like may be stored by the various storage devices 268 and/or within RAM 267. Such executable instructions, applications, program modules, and/or the like may include an operating system 280, a registration module 270, an alert module 260, a delivery options module 250, and identification module 245. As discussed in more detail below, these executable instructions, applications, program modules, and/or the like may control certain aspects of the operation of the carrier system 100 with the assistance of the processor 205 and operating system 280—although their functionality need not be modularized. In addition to the program modules, the carrier system 100 may store or be in communication with one or more databases, such as database 240.

Also located within the carrier system 100, in one embodiment, is a network interface 274 for interfacing with various computing entities (e.g., with one or more mobile stations 105). For example, the carrier system 100 may be able to receive data and/or messages from and transmit data and/or messages to the mobile station 105. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the carrier system's 100 components may be located remotely from other carrier system 100 components. Furthermore, one or more of the components may be combined and additional components performing functions described herein may be included in the carrier system 100.

### 2. Exemplary Mobile Station

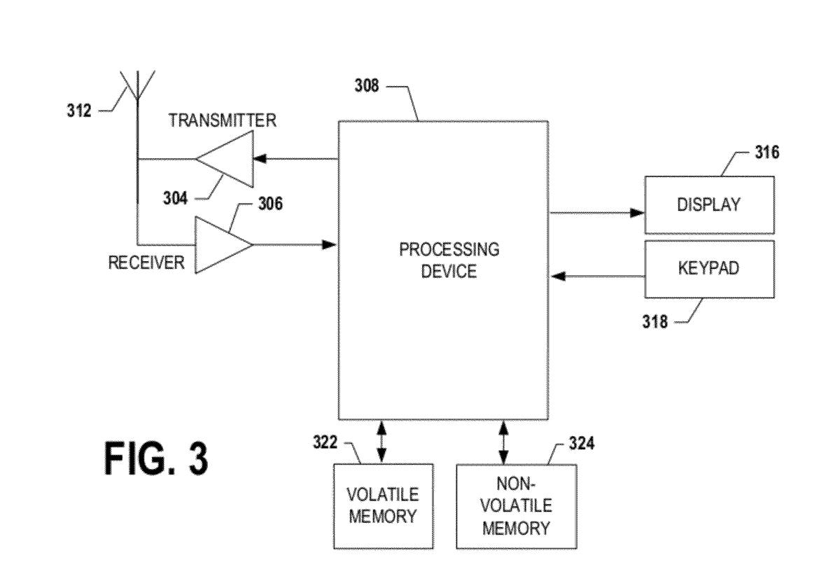

FIG. 3 provides an illustrative schematic representative of a mobile station 105 that can be used in conjunction with the embodiments of the present invention. Mobile stations 105 can be operated by various parties, including carrier personnel (e.g., delivery drivers, sorters, and/or the like). As shown in FIG. 3, the mobile station 105 can include an antenna 312, a transmitter 304 (e.g., radio), a receiver 306 (e.g., radio), and a processing device 308 (e.g., a processor, controller, and/or the like) that provides signals to and receives signals from the transmitter 304 and receiver 306, respectively.

The signals provided to and received from the transmitter 304 and the receiver 306, respectively, may include signaling information in accordance with an air interface standard of applicable wireless systems. In this regard, the mobile station 105 may be capable of operating with one or more air interface standards, communication protocols, modulation types, and access types. More particularly, the mobile station 105 may operate in accordance with any of a number of wireless communication standards and protocols, such as those described above with regard to the carrier system 100. In a particular embodiment, the mobile station 105 may operate in accordance with multiple wireless communication standards and protocols (e.g., using a Gobi radio), such as GSM, UMTS, 1xRTT, and EVDO, and use multiple wireless carriers. To do so, the mobile station 105 may include integrated mobile reception diversity and integrated power management. Such a configuration can provide for global connectivity to the user.

Via these communication standards and protocols, the mobile station 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile station 105 can also download changes, add-ons, and updates, for instance, to its firmware, software (e.g., including executable instructions, applications, program modules), and operating system.

According to one embodiment, the mobile station 105 may include a location determining device and/or functionality. For example, the mobile station 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile station 105 may also comprise a user interface (that can include a display 316 coupled to a processing device 308) and/or a user input interface (coupled to the processing device 308). The user input interface can comprise any of a number of devices allowing the mobile station 105 to receive data, such as a keypad 318, a touch display, voice or motion interfaces, or other input device. In embodiments including a keypad 318, the keypad 318 can include the conventional numeric (0-9) and related keys (#, *), and other keys used for operating the mobile station 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile station 105 can also include volatile memory 322 and/or non-volatile memory 324, which can be embedded and/or may be removable. For example, the non-volatile memory may be embedded or removable MMCs, secure digital SD memory cards, Memory Sticks, EEPROM, flash memory, hard disk, or the like. The memory can store any of a number of pieces or amount of information and data used by the mobile station 105 to implement the functions of the mobile station 105. The memory can also store content, such as computer program code for an application and/or other computer programs.

### 3. Exemplary Customer Computing Device

The customer computing devices 110 may each include one or more components that are functionally similar to those of the carrier system 100. For example, in one embodiment, each of the customer computing devices may include: (1) a processor that communicates with other elements via a system interface or bus; (2) a display device/input device; (3) transitory and non-transitory memory; and (4) a communications interface. These architectures are provided for exemplary purposes only and are not limiting to the various embodiments. The term “computing device” is used generically to refer to any computer, computing device, desktop, notebook or laptop, distributed system, carrier system, gateway, switch, or other processing device adapted to perform the functions described herein.

### III. EXEMPLARY SYSTEM OPERATION

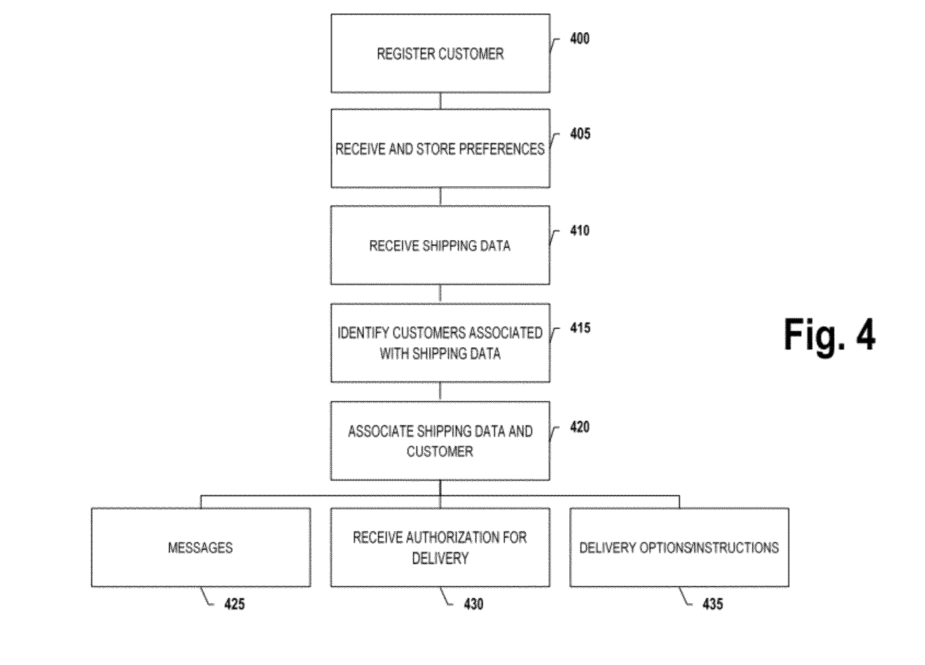

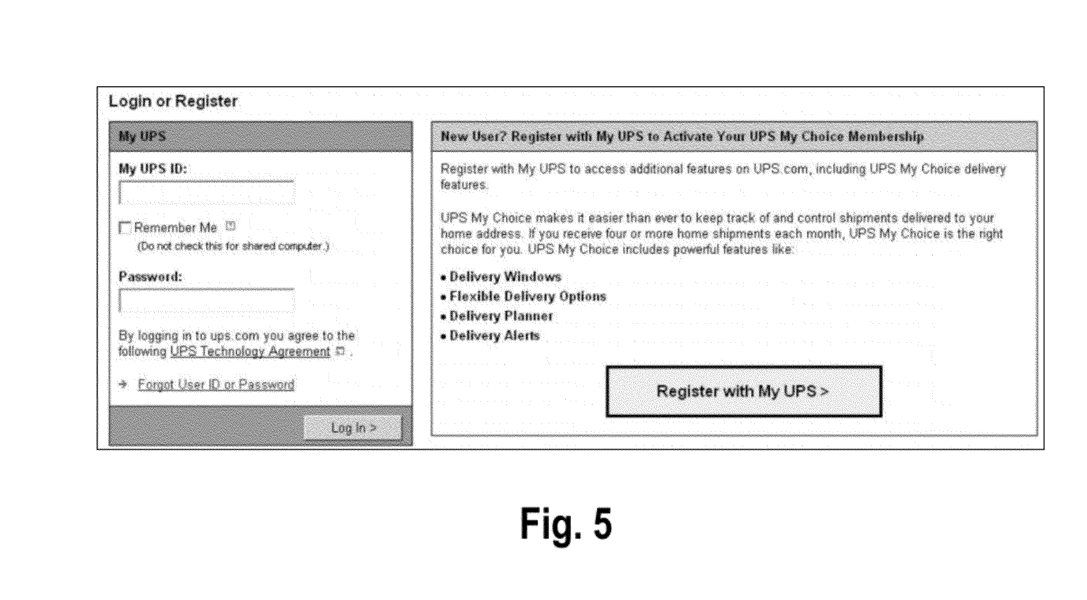

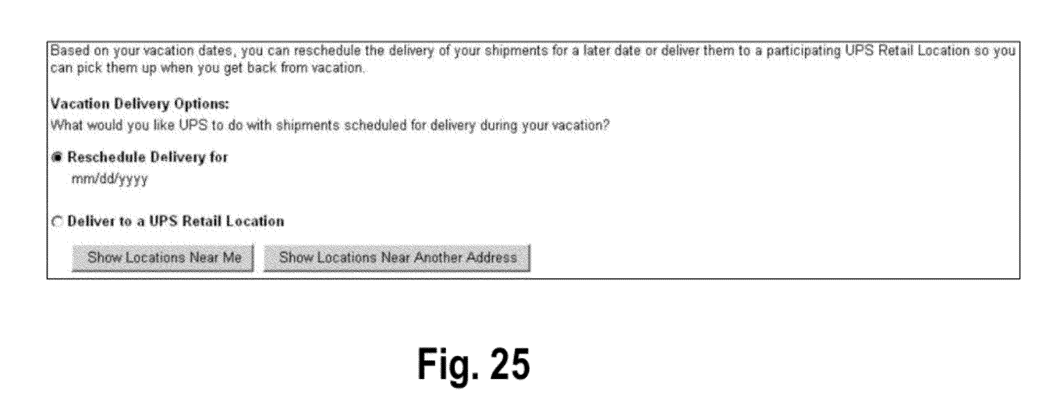

Reference will now be made to FIGS. 4-26. FIG. 4 is a flowchart illustrating operations and processes that may be performed for customer controlled management of shipments. FIGS. 5-26 show exemplary input and output for customer controlled management of shipments.

### 1. Registration

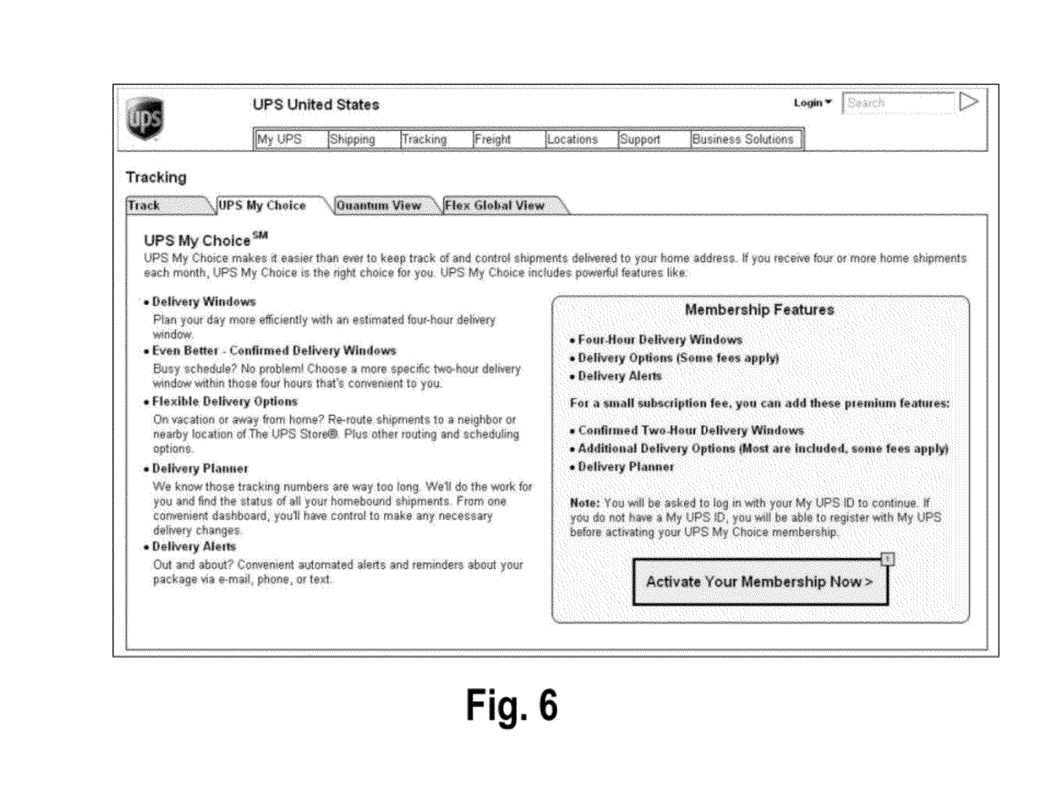

In one embodiment, as indicated in Block 400 of FIG. 4, the process may begin with the enrollment/registration of one or more customers for a customer delivery program. A customer may be an individual, a family, a company, an organization, an entity, a department within an organization, a representative of an organization and/or person, and/or the like. To register, a customer (e.g., a customer or customer representative operating a customer computing device 110) may access a webpage or portal of a carrier, such as United Parcel Service of America, Inc. (UPS). For instance, as shown in FIGS. 5 and 6, the carrier system 100 may transmit a webpage that provides the customer with an option of logging into a customer account or enrolling/registering for a customer delivery program.

In one embodiment, as part of the enrollment/registration process, the customer (e.g., a customer or customer representative operating a customer computing device 110) may be requested to provide biographic and/or geographic information by the carrier system 100 (e.g., via the registration module 270). For instance, the customer may provide the customer's name, such as a first name, a last name, a company name, an entity name, and/or an organization name. The customer may also provide any aliases associated with the customer. For instance, if the customer were an individual named Joseph Brown, the customer may provide Joe Brown or Joey Brown as aliases. The customer may also provide one or more addresses associated with the customer (e.g., street address, city, state, postal code, and/or country). For instance, Joseph Brown's address may be 105 Main Street, Atlanta, Ga. 30309, USA. As indicated, the customer may have multiple addresses associated with the account. For instance, Joseph Brown may have a home address and a business address associated with his account. Similarly, an organization may have multiple locations (e.g., addresses) associated with its account. When multiple addresses are provided, the customer may indicate which address should be used as the primary address. As will be recognized, the customer may provide other biographic and/or geographic information to adapt to various needs and circumstances.

In one embodiment, once the carrier system 100 receives the necessary biographic and/or geographic information from the customer, the carrier system 100 may perform one or more validation operations. For example, the carrier system 100 may determine whether the primary address (and/or other addresses) in the specified country or postal code is eligible for a customer delivery program. The carrier system 100 may also determine whether the primary address (and/or other addresses) is valid, e.g., by passing the primary address through one or more address cleansing or standardization systems. The carrier system 100 may perform a variety of fraud prevention measures as well, such as determining whether the customer or one of the customer's addresses has been “blacklisted” from customer delivery programs. As will be recognized, a variety of other approaches and techniques can be used to adapt to various needs and circumstances.

In one embodiment, the carrier system 100 may create a customer profile for the customer via the enrollment/registration process. Accordingly, the carrier system 100 may create and store various customer profiles (e.g., via database 240). In addition to at least the information described above, a customer profile may include one or more corresponding usernames and passwords. Additionally, the carrier system 100 may also create and store a customer identifier in association with the customer profile. In one embodiment, a customer identifier may be used to uniquely identify a customer profile. In another embodiment, a customer identifier may be used to uniquely identify a given address associated with a customer profile. In such an embodiment, if a customer profile is associated with four addresses, the carrier system 100 may create and store four customer identifiers in association with the customer profile. The customer identifier may also be stored in association with shipping data for an item to associate the item (and its shipping data) with the (a) correct customer (e.g., customer profile) and/or (b) correct address for a customer.

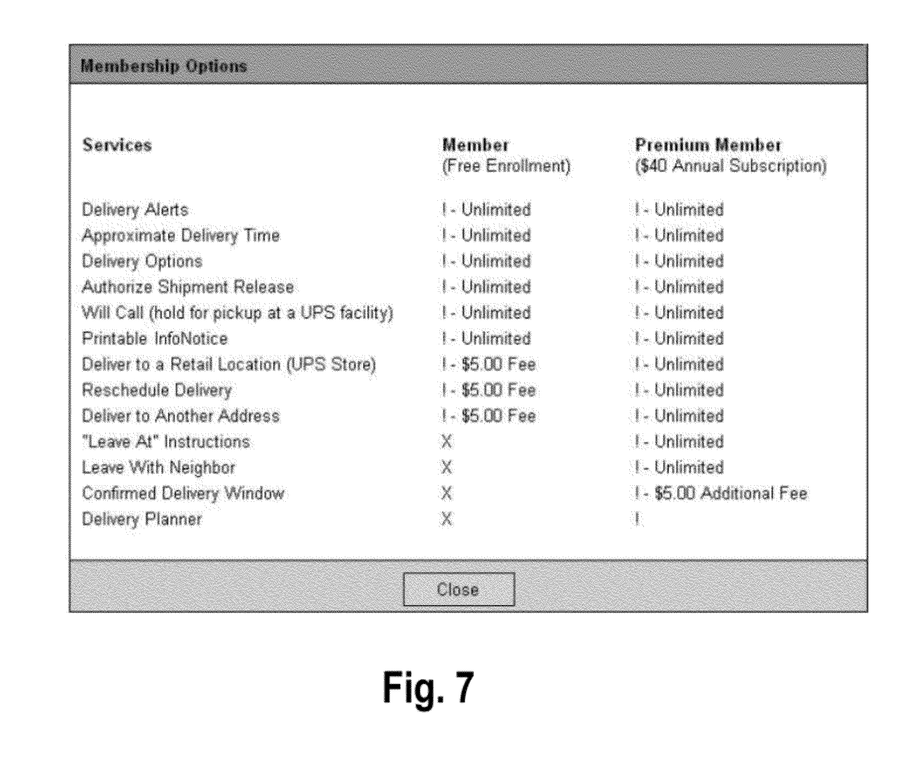

In one embodiment, a customer profile may correspond to one or more customer delivery programs. For instance, a customer (e.g., a customer or customer representative operating a customer computing device 110) may subscribe to a specific customer delivery program. In one embodiment, there may be several customer delivery programs from which to choose, such as a free customer delivery program and a premium customer delivery program. Each customer delivery program may have different benefits, such as those shown in FIG. 7 and Table 1 below.

TABLE 1
Membership Options

| | | Premium Member |
|---|---|---|
| | Member | ($40 Annual |
| Services | (Free Enrollment) | Subscription) |
| Delivery Alerts | !- Unlimited | !- Unlimited |
| Approximate Delivery Time | !- Unlimited | !- Unlimited |
| Delivery Options | !- Unlimited | !- Unlimited |
| Authorize Shipment Release | !- Unlimited | !- Unlimited |
| Will Call (hold for pickup at | !- Unlimited | !- Unlimited |
| a UPS facility) | | |
| Printable InfoNotice | !- Unlimited | !- Unlimited |
| Deliver to a Retail Location | !- $5.00 Fee | !- Unlimited |
| (UPS Store) | | |
| Reschedule Delivery | !- $5.00 Fee | !- Unlimited |
| Deliver to Another Address | !- $5.00 Fee | !- Unlimited |
| “Leave At” Instructions | X | !- Unlimited |
| Leave With Neighbor | X | !- Unlimited |
| Confirmed Delivery Window | X | !- $5.00 Additional |
| | | Fee |
| Delivery Planner | X | ! |

[symbol]

As shown in Table 1 above and in FIG. 7 for illustrative purposes, the free customer delivery program and the premium customer delivery program may have different benefits. For example, the free customer delivery program may allow customers to have access to certain features, e.g., delivery alerts, approximate delivery times, change delivery options, electronically authorize the release of an item, and/or route items to will call. Similarly, the premium customer delivery program (e.g., requiring a fee) may allow customers to have access to certain features in addition to those provided via the free customer delivery program, e.g., route items to other retail locations, reschedule deliveries, request that items be delivered to another address, and/or provide instructions for delivery. As will be recognized, these features are provided for illustrative purposes and are not limiting to embodiments of the present invention. Moreover, a variety of other approaches and techniques can be used to adapt to various needs and circumstances.

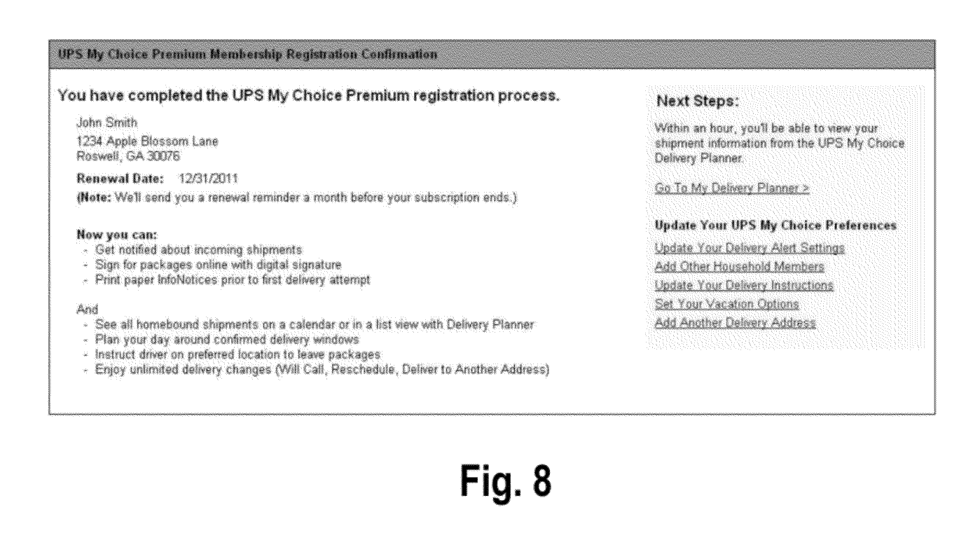

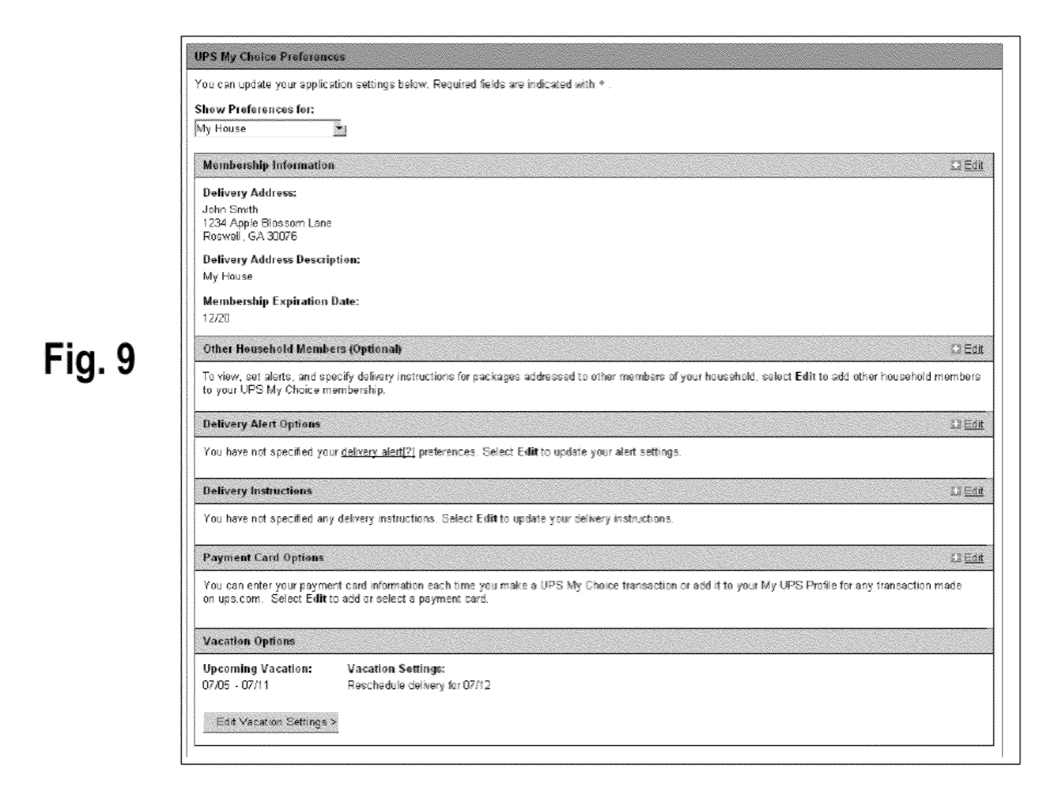

In one embodiment, once a customer profile has been created by the carrier system 100, the customer (e.g., a customer or customer representative operating a customer computing device 110) can provide various preferences associated with the customer delivery program to the carrier system 100 via a webpage (Block 405 of FIG. 4), for example. For instance, as shown in FIGS. 8 and 9, the customer (e.g., a customer or customer representative operating a customer computing device 110) can provide a variety of preferences, such communication preferences, delivery preferences, delivery options, and/or delivery instructions.

### 2. Customer and Item Matching

In one embodiment, once a customer profile has been created by the carrier system 100, one or more items to be delivered to the customer by the carrier may need to be identified. By identifying items to be delivered to the customer, the carrier system 100 can provide the customer with access to various features of a customer delivery program for the item. As will be recognized, an item may be a parcel or group of parcels, a package or group of packages, scrap metal banded together, a vehicle part, a box, a crate, a drum, a box strapped to a pallet, and/or the like. In one embodiment, each item may include an item/shipment identifier, such as a barcode, a MaxiCode, electronic representation, and/or text. The item/shipment identifier (e.g., 123456789) may be used by the carrier to identify and track the item as it moves through the carrier's transportation network. Such item/shipment identifiers can be affixed to items by, for example, using a sticker (e.g., label) with the item/shipment identifier printed thereon (in human and/or machine readable form) or an RFID tag with the item/shipment identifier stored therein.

In one embodiment, the carrier system 100 may store an item/shipment identifier in association with shipping data for the item. The shipping data may include information about the item, such as delivery service level. For example, the delivery service level may be Next Day Air, Next Day Air Early AM, Next Day Air Saver, 2nd Day Air, 2nd Day Air Early AM, 3 Day Select, and/or Ground. The shipping data may include information about the party shipping the item (e.g., consignor), such as the party's address, the party's phone number, the party's return address, the party's name, and/or the like. The shipping data may also include information about the customer to whom the item is to be delivered (e.g., consignee), such as the customer's address (e.g., delivery location), the customer's phone number, the customer's name, and/or the like.

In one embodiment, the shipping data may include information about the item itself and any tracking information. The tracking information may reflect the item's movement in the carrier's transportation network, including expected delivery date and time. To reflect the item's movement, an item/shipment identifier associated with the item may be scanned or otherwise electronically read at various points as the item is transported through the carrier's transportation network. For example, the item/shipment identifier may be automatically scanned by a barcode or MaxiCode device, an RFID interrogator, by a camera controller, or by a carrier employee using a handheld device (e.g., mobile station 105). In one embodiment, each time the item/shipment identifier is scanned or read, an appropriate device can transmit the item/shipment identifier and other appropriate information (e.g., location and time of the scan or reading) to the carrier system 100. The carrier system 100 can then receive and use the information to track the item as it is transported though the carrier's transportation network and update the shipping data accordingly.

In one embodiment, the carrier system 100 can use the shipping data to identify one or more customer profiles corresponding to the item (e.g., via the identification module 245). As described, each customer profile may include one or more addresses associated with the customer. Thus, when the carrier system 100 receives shipping data (or a portion of shipping data) for an item (Block 410 of FIG. 4), the carrier system 100 can determine whether the item corresponds to any customers enrolled/registered for a customer delivery program. In particular, the carrier system 100 can use the delivery address of the intended recipient (e.g., consignee or customer) in the shipping data for an item to identify any customer profiles with a substantially similar delivery address (Block 415 of FIG. 4). For example, if the shipping data of an item indicates that the delivery address of the intended recipient is 105 Main St., Atlanta, Ga. 30309, the carrier system 100 may identify Joseph Brown's customer profile as corresponding to the item even though the address in Joseph Brown's profile is 105 Main Street, Atlanta, Ga. 30309, USA. In other words, in making such determinations, the carrier system 100 can accommodate variations for a given address. As will be recognized, the carrier system 100 may be configured to compensate for various discrepancies.

In one embodiment, as a secondary measure, the carrier system 100 can use the delivery name of the intended recipient (e.g., consignee or customer) in the shipping data to confirm that the identified customer profile is correct. To do so, the carrier system 100 may compare the delivery name of the intended recipient in the shipping data to the primary name and/or any aliases in the identified customer profile. If the names are substantially similar, the carrier system 100 can confirm that the identified customer profile is correct. By way of example, if the shipping data indicates that the delivery name of the intended recipient is Joe Brown and Joseph Brown listed Joe as a first name alias, the carrier system 100 could confirm Joseph Brown's customer profile as corresponding to the item. As will be recognized, a variety of other approaches and techniques can be used to identify a customer profile corresponding to at least one item to be delivered by the carrier.

In one embodiment, after identifying the appropriate customer profile, the carrier system 100 can associate the shipping data with the customer profile (Block 420 of FIG. 4). This may include appending the shipping data with the appropriate customer identifier (or other identifier corresponding to the customer profile). For instance, the shipping data for all shipments corresponding to Joseph Brown's customer profile may be appended with the customer identifier (or other identifier) created for Joseph Brown. In various embodiments, using this approach allows items (and their shipping data) to be linked to appropriate customer profiles. Thus, when Joseph Brown accesses his account, he can view all of his shipments (e.g., those shipments with shipping data appended with his customer identifier (or other identifier)). Similarly, any actions selected by the customer for an item can be passed to the shipping data for the item.

### 3. Item Tracking

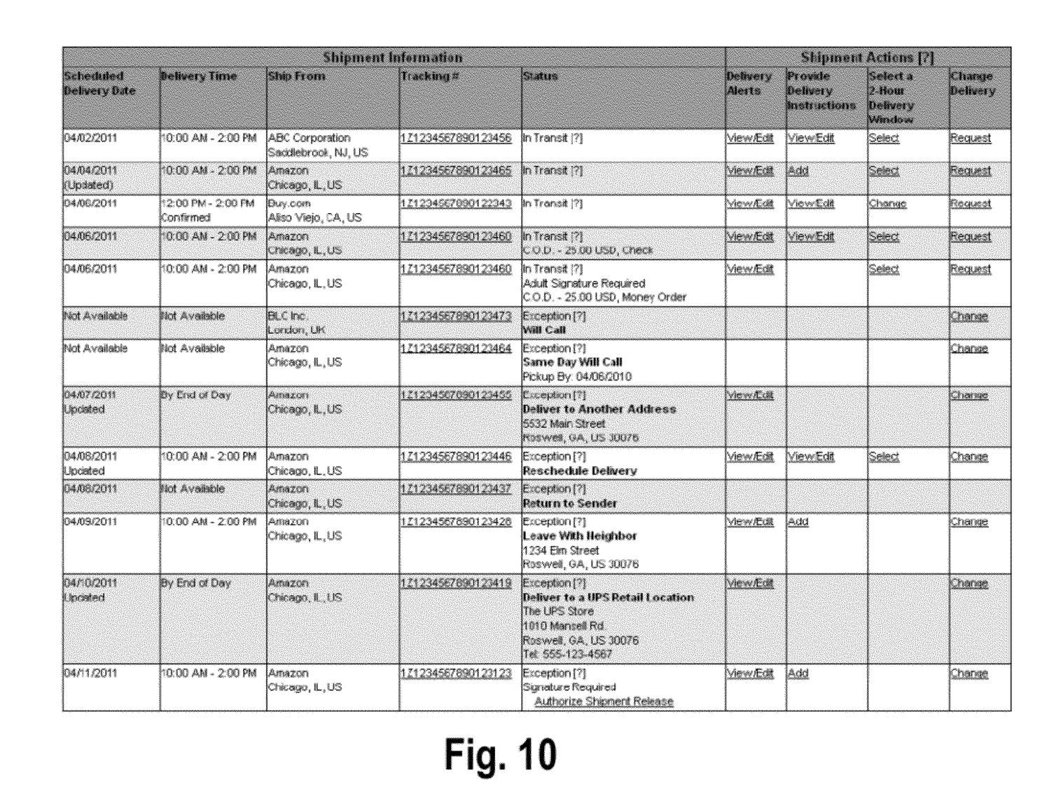

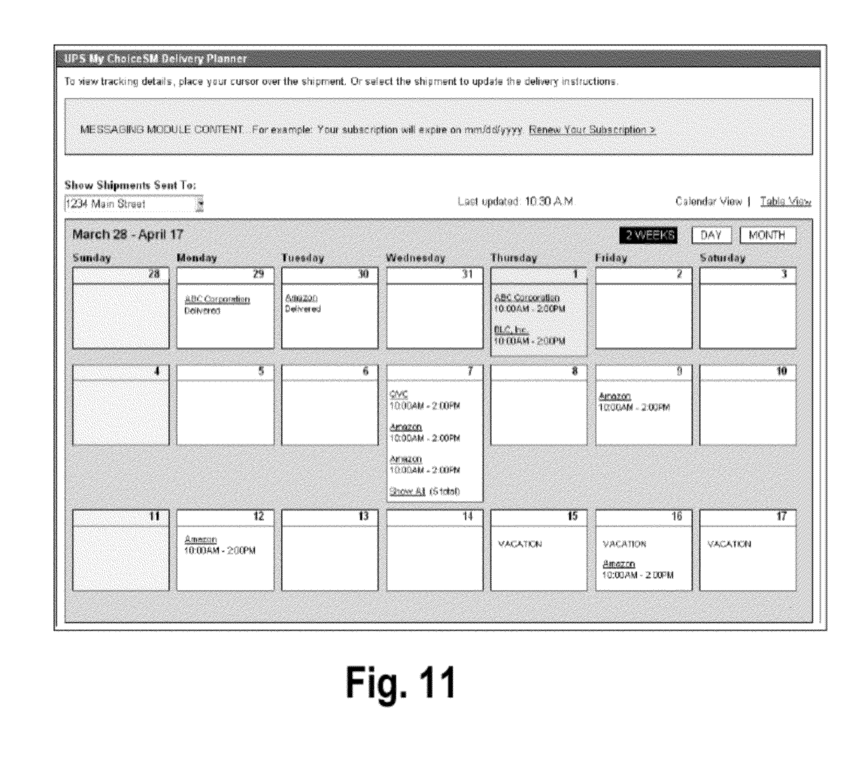

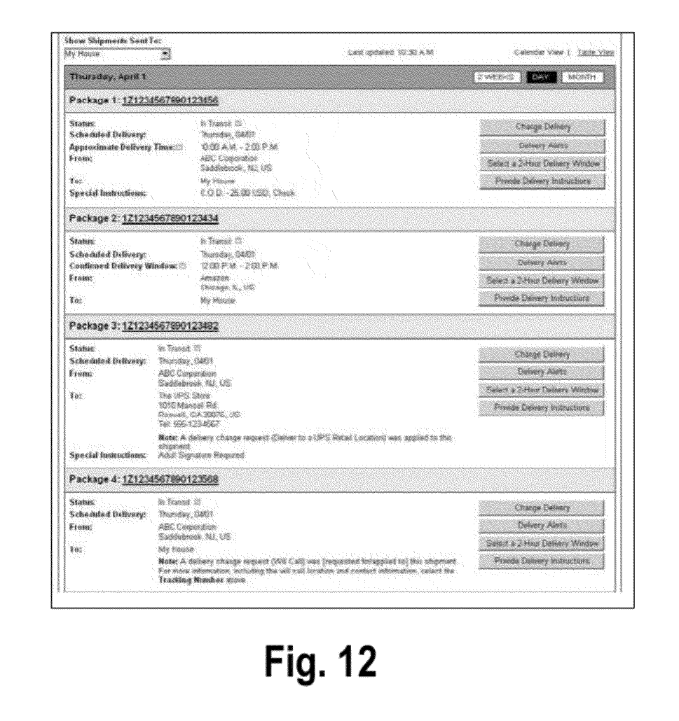

In one embodiment, by appending the shipping data with the appropriate customer identifier, the corresponding customer can view tracking information for any shipments associated with the customer profile. For instance, as shown in FIGS. 10-12, the carrier system 100 can be used to identify (e.g., retrieve the shipping data with the appropriate customer identifier) all shipments associated with a customer (e.g., customer profile) using the customer identifier and provide them to the customer for viewing in a customer-friendly format, such as via a dashboard/webpage. For example, FIG. 10 shows a dashboard/webpage with a list of all inbound shipments to a customer. FIG. 11 shows dashboard/webpage with a calendar (which may have a day view, a week view, a multiple week view, and/or a month view) having a list of all inbound shipments to a customer. In FIG. 11, the calendar is sorted by delivery address, indicating that the customer has more than one delivery address associated with the customer profile. FIG. 12 shows another dashboard/webpage with a list of all inbound shipments to a customer.

In various embodiments, these concepts can provide customers with ongoing visibility of all inbound packages, as well as preferences. For instance, for each item, the dashboard/webpage can be used to show the item/shipment identifier, a delivery indicator, last activity scan date, a non-confirmed delivery window, a confirmed delivery window a commit time, whether an in-person signature is requested for delivery, a delivery service level, and/or various other information. As will be recognized, though, a variety of other approaches and techniques can be used to provide tracking information to a customer.

### 4. Messages

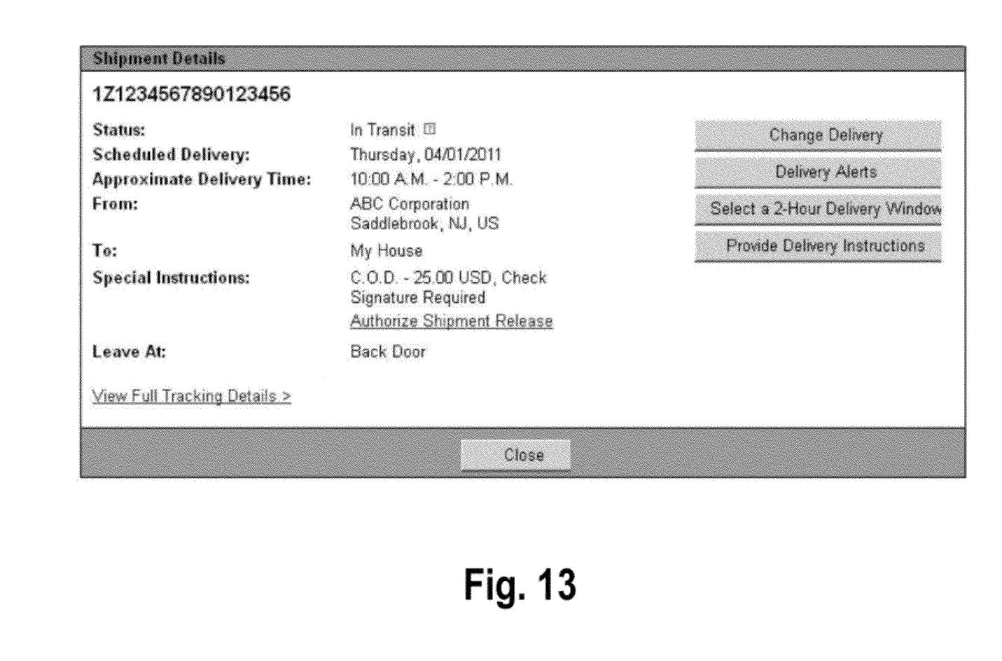

In one embodiment, the dashboard/webpage (or other mechanism) provided by the carrier system 100 can be used to customize and/or provide communication preferences regarding items to be delivered to customers (shown in FIG. 13). For example, the communication preferences may provide customers with the ability to request messages for items before the carrier attempts to deliver the items (e.g., prior to the first delivery attempt by the carrier) and/or after items have been delivered.

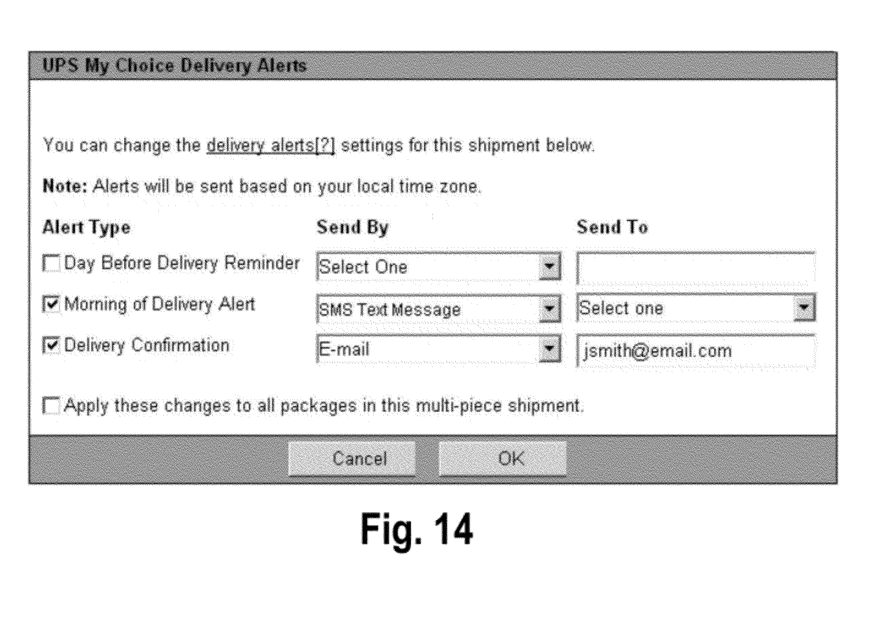

In one embodiment, as shown in FIG. 14, a customer (e.g., a customer or customer representative operating a customer computing device 110) can identify one or more communication formats for communicating with the customer. The communication formats may include text messages (e.g., Short Message Service (SMS) and/or Multimedia Messaging Service (MMS), email messages, voice messages, and/or a variety of other messages in various communication formats. In addition to identifying one or more communication formats, the customer (e.g., a customer or customer representative operating a customer computing device 110) can identify the corresponding electronic destination addresses to be used in providing information regarding items to be delivered to the customer. For instance, for text messages, the customer may provide one or more cellular phone numbers. For email messages, the customer may provide one or more email addresses. And for voice messages, the customer may provide one or more cellular or landline phone numbers. Additionally, in one embodiment, validation operations can be performed with respect to each input destination address—to ensure their accuracy.

In one embodiment, customers (e.g., a customer or customer representative operating a customer computing device 110) may indicate the type of messages they want to receive (e.g., the content). For example, a customer may indicate that he only wants to receive messages when the shipping data for an item indicates that an in-person signature from the customer is requested for delivery of the item. In another example, a customer may indicate that he wants to receive messages for all items to be delivered to the customer with expected delivery dates and delivery times. As will be recognized, customers may indicate that they want to receive messages regarding items in a variety of other circumstances.

In one embodiment, customers (e.g., a customer or customer representative operating a customer computing device 110) may identify/define time periods in which the messages providing information regarding items to be delivered should be transmitted to the customer. For instance, the time periods may include (a) after shipment and the day before an item is delivered and (b) after shipment and the morning of the day of delivery. In such cases, the messages can serve as a reminder to the customer that an item is being delivered. Similarly the time periods may be after delivery for confirmation of delivery. The carrier system 100 can store communication preferences for providing information in association with the customer profiles. Moreover, the communication preferences may apply to the customer profile globally, to selected customer addresses, to groups of items, and/or an item-by-item basis.

In one embodiment, the carrier system 100 may impose time constraints for placing, generating, and/or transmitting messages within the time periods identified by the customers. For example, the carrier system 100 may only transmit text messages to customers between 6:00 am-11:00 pm (based on time zones). Similarly, the carrier system 100 may place calls and transmit automated voice messages between 8:00 am-9:00 pm (based on time zones). And for email messages, the carrier system 100 may generate and transmit them without time constraints.

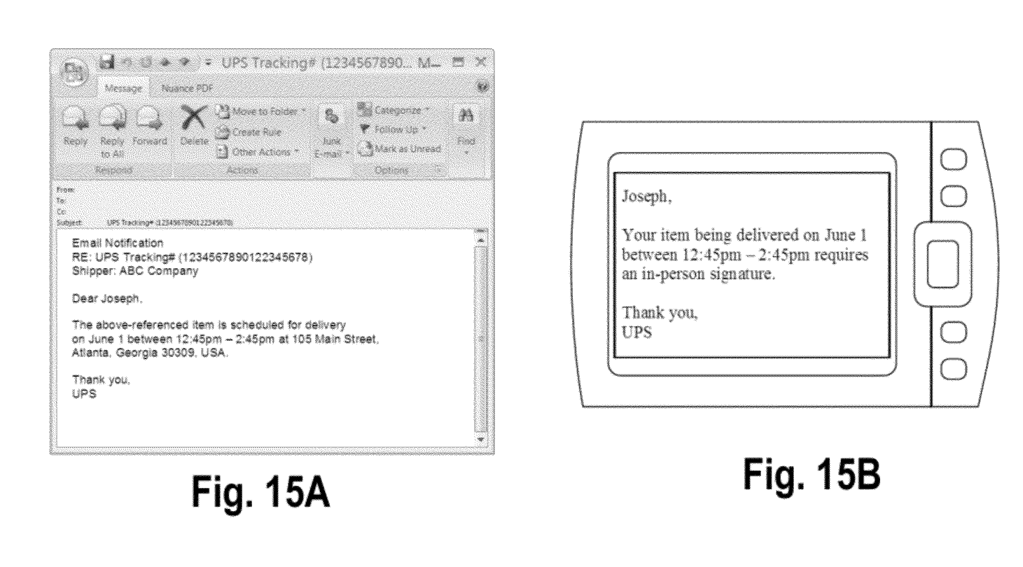

In one embodiment, the carrier system 100 can automatically generate (e.g., via the message module 260) one or more messages providing information regarding an item to be delivered to the customer (Block 425 of FIG. 4) in compliance with the customer's communication preferences and the carrier's time constraints. Similarly, the carrier system to 100 can automatically transmit the one or messages to the electronic destination addresses in compliance with the customer's communication preferences and the carrier's time constraints. For example, the carrier system 100 may generate (including select) and transmit an email message to Joseph Brown's email address and a text message to Joseph's cellular phone the day before an item is to be delivered to Joseph's home address. The messages may indicate the expected delivery date and/or delivery time, such as shown in FIGS. 15A and 15B, and a variety of other information. As will be recognized, a variety of other operations and processes may be used with embodiments of the present invention. These operations and processes can be customized to adapt to various needs and circumstances.

### 5. Delivery Times

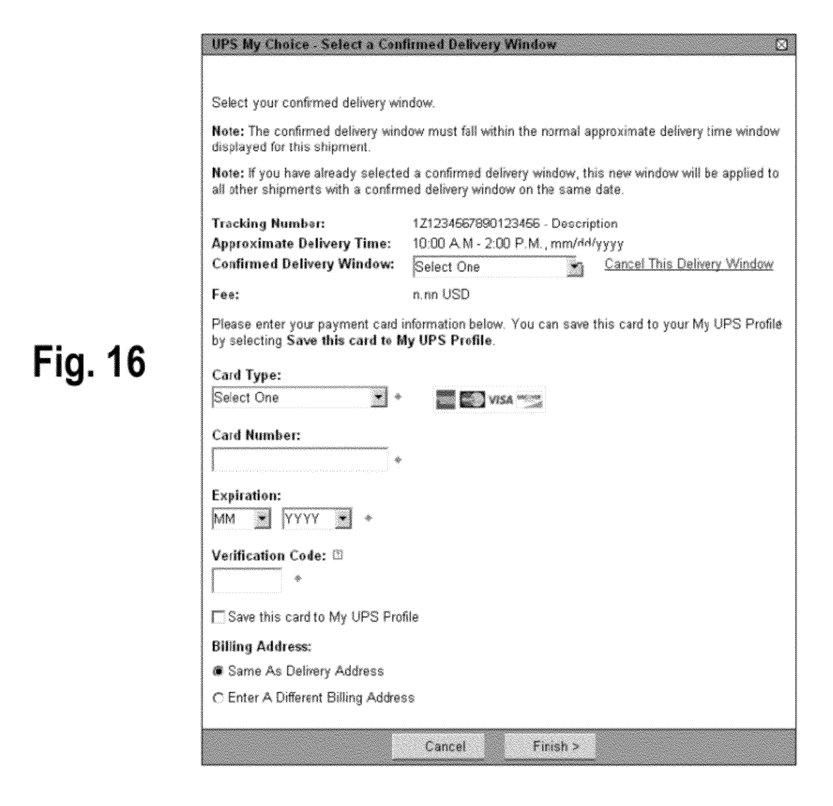

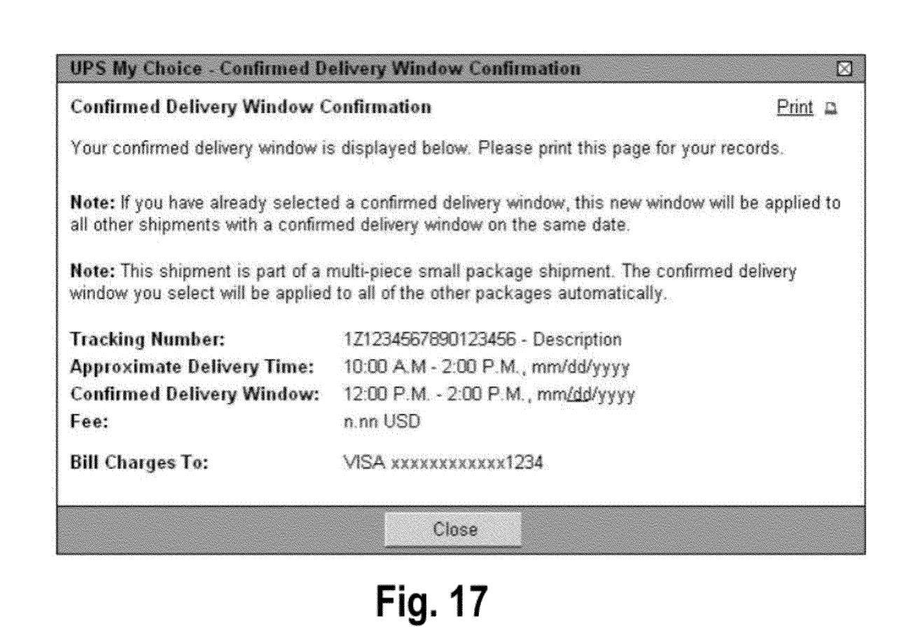

In one embodiment, the dashboard/webpage (or other mechanism) can be used to view expected delivery times (estimate delivery windows and/or confirmed delivery windows). In one embodiment, estimated time windows may indicate an estimated delivery time of an item based on historical delivery times to the area. Such information may be included in messages to customers prior to the first delivery attempt. As shown in FIG. 13, the dashboard/webpage may also be used by the customer (e.g., operating a customer computing device 110) to request that items be delivered within a delivery window. That is, the customer may want an item delivered within a specific time window. The carrier may provide such services as part of a customer delivery program or on a fee basis, as shown in FIGS. 16 and 17. Table 2 below provides illustrative estimated delivery windows and confirmed delivery windows from which the customer can select to have an item delivered.

TABLE 2

| Estimated Delivery Windows | Confirmed Delivery Windows |
|---|---|
| 11:45 am-3:45 pm | 11:45 am-1:45 pm |
| | 12:45 pm-2:45 pm |
| | 1:45 pm-3:45 pm |
| 11:30 am-3:30 pm | 11:30 am-1:30 pm |
| | 12:30 pm-2:30 pm |
| | 1:30 pm-3:30 pm |
| 2:00 pm-5:45 pm | 2:00 pm-4:00 pm |
| | 3:45 PM-5:45 pm |
| 1:00 pm-4:15 pm | 1:00 pm-3:00 pm |
| | 2:15 pm-4:15 pm |
| 8:00 am-11:00 pm | 8:00 am-10:00 am |
| | 9:00 am-11:00 am |
| 3:00 pm-6:00 pm | 3:00 pm-5:00 pm |
| | 4:00 pm-6:00 pm |
| 3:00 pm-5:45 pm | 3:00 pm-5:00 pm |
| | 3:45 pm-5:45 pm |
| 4:00 pm-6:00 pm | 4:00 pm-6:00 pm |

Additional information regarding estimated delivery windows and confirmed delivery windows can be found in U.S. Pat. No. 6,701,299, U.S. Pat. No. 7,233,907, and U.S. Pat. No. 7,925,524, all of which are incorporated herein in their entireties by reference. As will be recognized, a variety of other operations and processes may be used with embodiments of the present invention. These operations and processes can be customized to adapt to various needs and circumstances.

### 6. Electronic Authorization for Item Release

In one embodiment, consignors, consignees, and/or the carrier may request that a recipient's signature be obtained at the point of delivery for certain items. In-person signature requests may be for high-value and/or high-risk items, such as cellular phones, computers, narcotic medications, and/or a variety of other items. Similarly, in-person signature requests may be designated by the carrier for items being delivered in non-driver release areas. A non-driver release area may be an area in which items have been stolen after being left at the delivery location (e.g., not delivered to a person) and/or for various other reasons.

In one embodiment, items that are shipped with a request for an in-person signature at the point of delivery may have a non-driver release status. The non-driver release status may be indicated in the shipping data. For example, the shipping data for an item may indicate that an in-person signature from a recipient (e.g., customer or representative of the customer) is requested for delivery of the item. Such information may be displayed via the dashboard/webpage (shown in FIG. 13). For instance, the shipping data for the item represented in FIG. 13 indicates that an in-person signature is requested for delivery of the item. In addition to an in-person signature, in this example, payment of $25.00 is also needed for delivery.

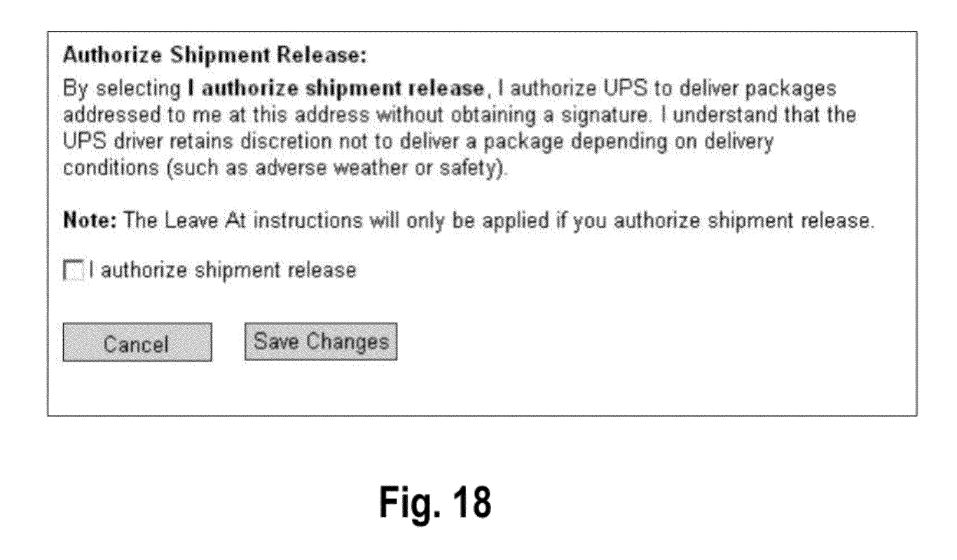

In one embodiment, the customer (e.g., a customer or customer representative operating a customer computing device 110) may electronically authorize delivery of the item without an in-person signature. To do so, the customer (e.g., a customer or customer representative operating a customer computing device 110) may electronically authorize release of the item without an in-person signature through the dashboard/webpage provided by the carrier system 100, for example. Operatively, in one embodiment, the customer (e.g., a customer or customer representative operating a customer computing device 110) may select a hyperlink (e.g., shown in FIG. 13) that reads “Authorize Shipment Release.” After (e.g., in response to) the carrier system 100 receives the request to authorize shipment release, the carrier system 100 can provide the appropriate webpage and information to the customer. For instance, as shown in FIG. 18, the carrier system 100 may provide a dashboard/webpage to the customer (e.g., displayed via a customer computing device 110) that provides a disclaimer for delivering the item without an in-person signature (e.g., delivering the item by leaving it at a front door of a house). The dashboard/webpage may require the customer to check a box, type in his name, and/or to perform other affirmative steps. The customer computing device 110 can then transmit the input authorization to the carrier system 100. The carrier system 100 can then receive the input authorization to deliver the item without an in-person signature (Block 430 of FIG. 4). After (e.g., in response to) receiving the authorization, the carrier system 100 can update the shipping data to reflect that the item can now be delivered without an in-person signature at the point of delivery.

In certain embodiments, an electronic authorization may have the same effect as an in-person signature at the point of the delivery. Such electronic signatures may apply to the customer profile globally (e.g., allowing all items for a particular address to be delivered without in-person signatures), to selected customer addresses, to groups of items, and/or an item-by-item basis. Such authorizations may be provided prior to the first delivery attempt by the carrier, further streamlining carrier operations and increasing customer satisfaction.

In addition to providing for electronic authorization to release items, the carrier system 100 can provide for payment of items so that cash-on-delivery items do not require an in-person transaction for delivery. As will be recognized, a variety of other operations and processes may be used with embodiments of the present invention. These operations and processes can be customized to adapt to various needs and circumstances.

### 7. Instructions for Delivery

In one embodiment, delivery persons working for a carrier (and other carrier personnel) may carry and operate mobile stations 105 to assist in the delivery of items. For example, shipping data (or at least a portion of shipping data) corresponding to items to be delivered can be regularly, periodically, and/or continuously transmitted to the appropriate mobile stations 105. Thus, for instance, carrier personnel can scan an item/shipment identifier on an item (e.g., using a mobile station 105) to view information about the delivery of the item. The mobile station 105 may also be used to provide instructions for delivery to a delivery person. The instructions may include information, such as where an item should be left at a delivery location and/or access codes needed to deliver an item. The delivery person can also use the mobile station 105 to record information about the delivery of the item, such as where and at what time the item was delivered.

As will be recognized, in one embodiment, a dashboard/webpage (or other mechanism) provided by the carrier system 100 (e.g., via the delivery options module 250) can be used to provide instructions regarding items to be delivered to customers (e.g., prior to a delivery attempt by the carrier). For example, the customer (e.g., a customer or customer representative operating a customer computing device 110) may access the dashboard/webpage to view items to be delivered to the customer. The dashboard/webpage may also provide the customer with the option of providing instructions for delivering one or more items.

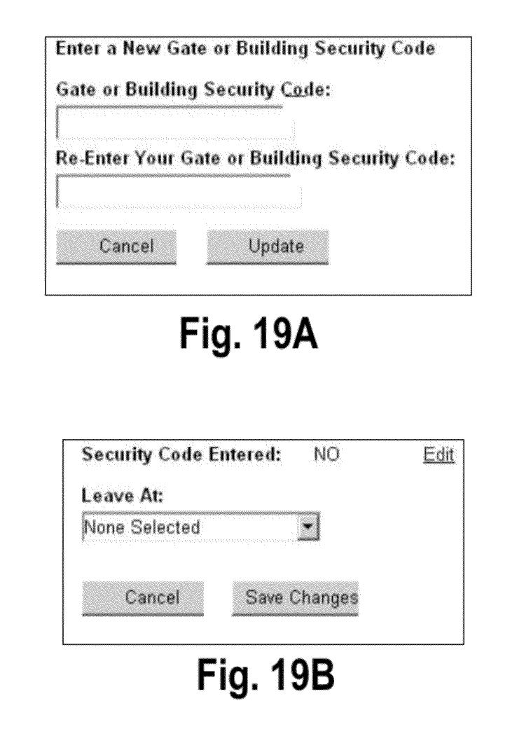

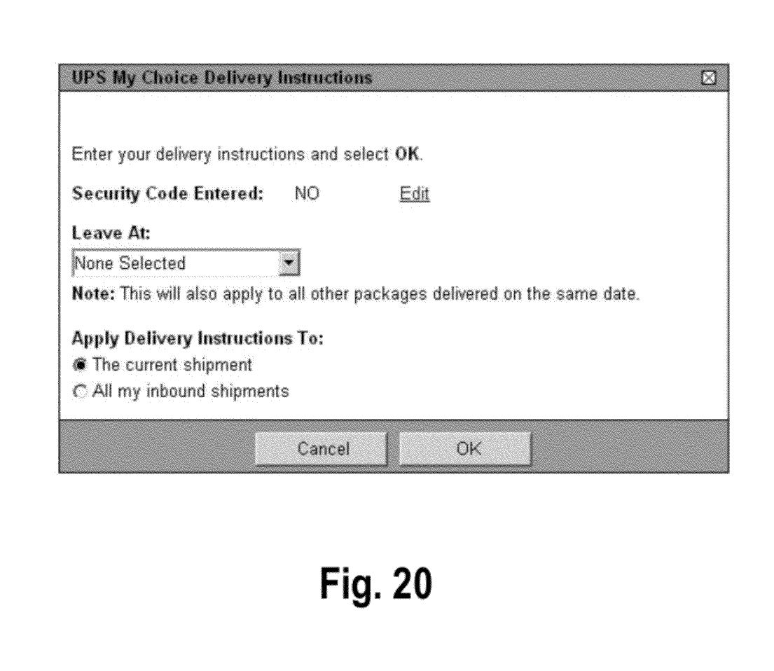

In one embodiment, to provide such instructions, the customer (e.g., a customer or customer representative operating a customer computing device 110) may select a button (e.g., shown in FIG. 13) that reads “Provide Delivery Instructions.” After (e.g., in response to) the carrier system 100 receives the request to provide instructions, the carrier system 100 can provide the appropriate dashboard/webpage and information to the customer. For instance, as shown in FIGS. 19A, 19B, and 20, the carrier system 100 may provide a dashboard/webpage to the customer (e.g., displayed via a customer computing device 110) that provides the ability to input (e.g., via an input form) one or more instructions for using a code to enter an area proximate the delivery address, such as building code(s), door code(s), and/or gate code(s). The carrier system 100 may also provide a dashboard/webpage to the customer (e.g., displayed via a customer computing device 110) that provides the ability to input (e.g., via a drop-down menu) one or more instructions that identify a location at the delivery address at which the item should be left. Table 3 below provides illustrative instructions and corresponding codes.

TABLE 3

| Leave - At Instructions | Optional |
|---|---|
| Leave at - Front Door | Security Code to Access Front Door |
| Leave at - Rear Door | Security Code to Access Rear Door |
| Leave at - Side Door | Security Code to Access Side Door |
| Leave at - Garage | Security Code to Access Garage |
| Leave at - Porch | Security Code to Access Porch |
| Leave at - Deck | Security Code to Access Deck |
| Leave at - Patio | Security Code to Access Patio |
| Leave at - Reception | Security Code to Access Reception |
| Leave at - Management Office | Security Code to Access Office |
| Leave at - Door Person | Security Code to Reach Door Person |
| Leave at - Neighbor | Security Code for Neighbor |

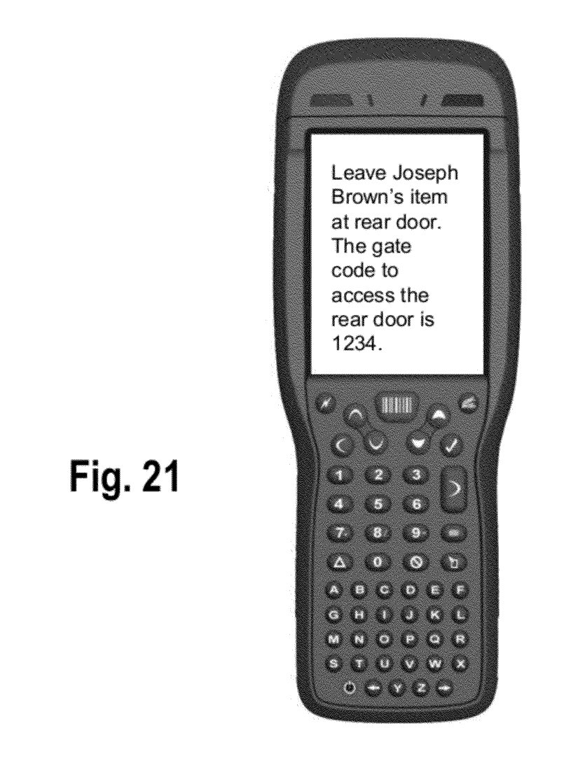

In one embodiment, as indicated in Block 435 of FIG. 4, the carrier system 100 can receive the one or more instructions for delivery (e.g., before a first delivery attempt). After (e.g., in response to) receiving the one or more instructions for delivery, the carrier system 100 can update the shipping data to reflect that the item should be delivered in accordance with the one or more instructions. The updated shipping data (or at least a portion of update shipping data) can be regularly, periodically, and/or continuously transmitted by the carrier system 100 to the appropriate mobile stations 105. The appropriate mobile station 105 can receive the updated shipping data (or at least a portion of update shipping data). Then, a delivery person can scan an item/shipment identifier on an item (e.g., using a mobile station 105) to view information about the delivery of the item, and the updated shipping data (or at least a portion of update shipping data) can be displayed, including the one or more instructions for delivery. The delivery person can then delivery the item in accordance with the one or more instructions for delivery. For instance, as shown in FIG. 21. The instructions may be to leave an item at a rear door at a delivery location and further provide a gate code needed to access the rear door. A variety of other instructions for delivery can be provided as well.

As will be recognized, the one or more instructions for delivery may apply to the customer profile globally (e.g., providing that all items be delivered in accordance with the instructions), to selected customer addresses, to groups of items, and/or an item-by-item basis. As indicated, such instructions may be provided prior to the first delivery attempt by the carrier. Moreover, a variety of other operations and processes may be used with embodiments of the present invention. These operations and processes can be customized to adapt to various needs and circumstances. For instance, the carrier may include such services as part of a customer delivery program and/or require a fee.

### 8. Delivery Options

In one embodiment, as described, shipping data (or at least a portion of shipping data) corresponding to items to be delivered can be regularly, periodically, and/or continuously transmitted by the carrier system 100 to the appropriate mobile stations 105. Thus, for instance, carrier personnel can scan an item/shipment identifier on an item (e.g., using a mobile station 105) to view information about the delivery of the item. In one embodiment, shipping data can be updated to change delivery options, such as changing the delivery location, the delivery date, and/or the delivery time.

### A. Non-Vacation Delivery Options

In one embodiment, a dashboard/webpage (or other mechanism) provided by the carrier system 100 (e.g., via the delivery options module 250) can be used to change delivery options regarding items to be delivered to customers (e.g., prior to a delivery attempt by the carrier). For example, the customer (e.g., a customer or customer representative operating a customer computing device 110) may access the dashboard/webpage provided by the carrier system 100 to view items to be delivered to the customer. The dashboard/webpage may provide the customer with the option of changing delivery options for one or more items.

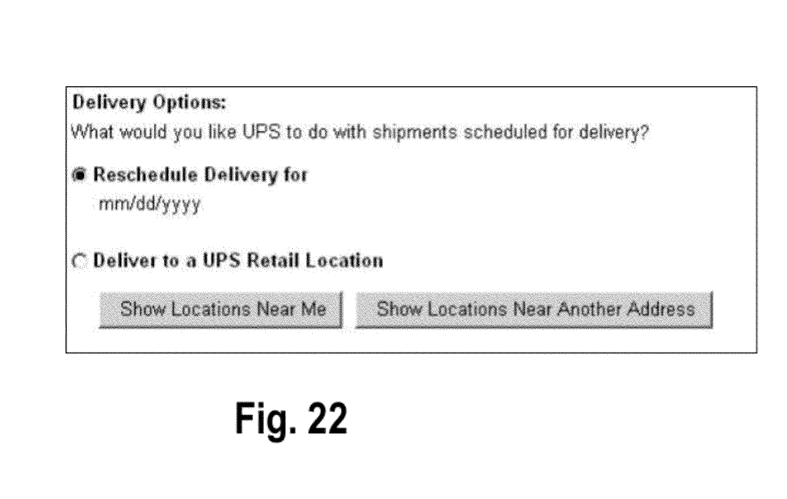

In one embodiment, to change delivery options, the customer (e.g., a customer or customer representative operating a customer computing device 110) may select a button (e.g., shown in FIG. 13) that reads “Change Delivery.” After (e.g., in response to) the carrier system 100 receives the request to change delivery options, the carrier system 100 can provide the appropriate dashboard/webpage and information to the customer. For instance, as shown in FIG. 22, the carrier system 100 may provide a dashboard/webpage to the customer (e.g., displayed via a customer computing device 110) that provides the ability to change delivery options. The delivery options may allow the customer to request to have the item held at a carrier facility for pick up (e.g., will call or same day will call). The delivery options may allow the customer to request to reschedule delivery of the item for another date and/or time (e.g., a future date and time). The delivery options may allow the customer to change the delivery service level of the item (e.g., change the delivery service level from Ground to 2nd Day Air) after the item has been shipped. In one embodiment, this may allow for the item to be delivered earlier than initially indicated (e.g., both day and time). The delivery options may allow the customer request to change the delivery location to a carrier facility (or other location), such as a UPS Store. And the delivery options may allow the customer to request to return the item to the consignor. As will be recognized, embodiments of the present invention may also allow a customer to change a variety of other delivery options.

In one embodiment, as indicated in Block 435 of FIG. 4, the carrier system 100 can receive the changed delivery options as input from the customer. After (e.g., in response to) the changed delivery options, the carrier system 100 can accept the requested changes (e.g. including validating the changes). The carrier system 100 can then update the shipping data to reflect that the item should be delivered in accordance with the changed delivery options. In one embodiment, the change in delivery options may require applying a new item/shipment identifier and/or label. For example, as described, the updated shipping data (or at least a portion of update shipping data) corresponding to items to be delivered can be regularly, periodically, and/or continuously transmitted by the carrier system 100 to the appropriate mobile stations 105 (and/or other computing entities).

In one embodiment, the appropriate mobile stations 105 (and/or other computing entities) can receive the updated shipping data (or at least a portion of update shipping data) corresponding to items to be delivered. Thus, carrier personnel sorting items or loading delivery vehicles can scan an item/shipment identifier (e.g., using a mobile station 105) on an item to view information about the delivery of the item, and the updated shipping data (or at least a portion of update shipping data) can be displayed. The updated shipping information may indicate that a new label (and/or item/shipment identifier) be affixed to the item (e.g., the new label may indicate the new delivery address). The item can then be delivered in accordance with the changed delivery options.

In various embodiments, the carrier may include such services as part of a customer delivery program and/or require a fee. As indicated, in one embodiment, the delivery options may be changed prior to the first delivery attempt by the carrier. Moreover, a variety of other operations and processes may be used with embodiments of the present invention. These operations and processes can be customized to adapt to various needs and circumstances.

### B. Vacation Delivery Options

In one embodiment, a dashboard/webpage (or other mechanism) provided by the carrier system 100 (e.g., via the delivery options module 250) can be used to change delivery options regarding items to be delivered to customers while the customers are on vacation (or otherwise away from the delivery location, such as being out of town on a business trip). For example, a customer (e.g., a customer or customer representative operating a customer computing device 110) may access the dashboard/webpage provided by the carrier system 100 to input delivery options while the customer is on vacation.

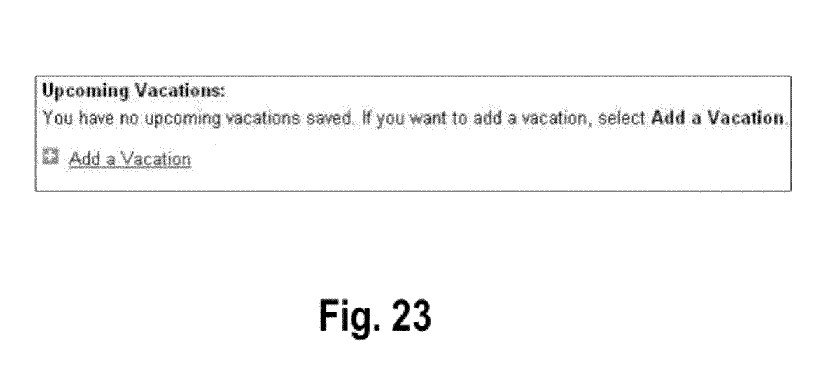

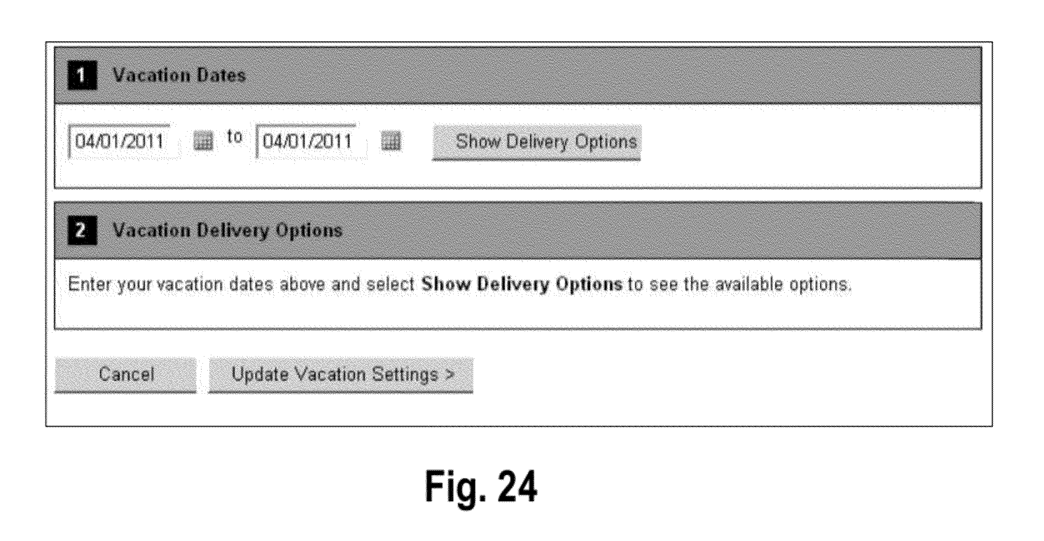

In one embodiment, to input such delivery options, the customer (e.g., a customer or customer representative operating a customer computing device 110) may select a button (e.g., shown in FIG. 23) that reads “Add a Vacation.” After (e.g., in response to) the carrier system 100 receives the request to add a vacation, the carrier system 100 can provide the appropriate dashboard/webpage and information to the customer. For instance, as shown in FIGS. 24, 25, 26A, and 26B, the carrier system 100 may provide a dashboard/webpage to the customer (e.g., displayed via a customer computing device 110) that provides the ability to input vacation dates and/or delivery options (e.g., the delivery location, the delivery date, and/or the delivery time). During the vacation time period, the delivery options may allow the customer to request to have items held at a carrier facility for will call or to be rescheduled for delivery on another date. Similarly, during the vacation time period, the delivery options may allow the customer to request to have all items delivered to a carrier facility, such as a UPS Store.

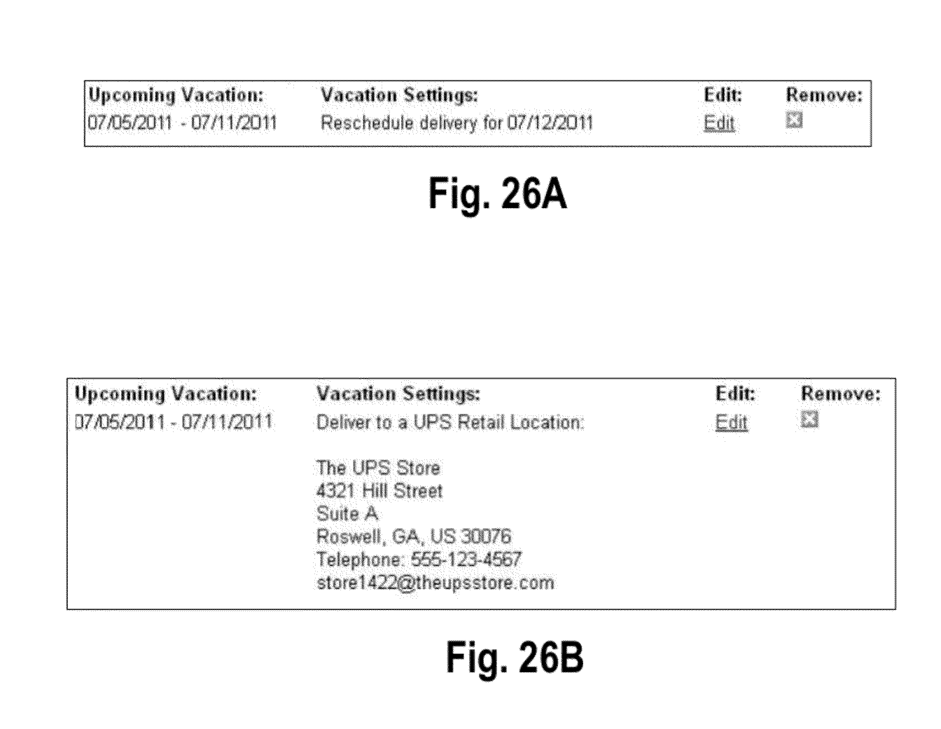

In one embodiment, as indicated in Block 435 of FIG. 4, the carrier system 100 can receive the input vacation dates and/or delivery options. After (e.g., in response to) receiving the input vacation dates and/or delivery options, the carrier system 100 can apply the vacation delivery options to all items to be delivered to the customer (and/or one of the customer's addresses in his customer profile) during the vacation time period. For instance, as shown in FIG. 26A, all items to be delivered to a customer between Jul. 5, 2011 and Jul. 11, 2011 can be rescheduled for delivery on Jul. 12, 2011. Similarly, as shown in FIG. 26B, all items to be delivered to a customer between Jul. 5, 2011 and Jul. 11, 2011 can be delivered to a carrier facility (such as a UPS Store) for later pickup by the customer. In one embodiment, vacation options may require applying a new label (and/or item/shipment identifier) to items to be delivered during the vacation time period.

In various embodiments, the carrier may include such services as part of a customer delivery program and/or require a fee. As will be recognized, a variety of other operations and processes may be used with embodiments of the present invention. These operations and processes can be customized to adapt to various needs and circumstances.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing at least one instruction for delivering at least one item to a customer by a carrier, the method comprising:
storing, via a carrier system, shipping data corresponding to an item to be delivered to a customer by a carrier;
receiving, via the carrier system, at least one instruction for delivering the item, wherein the at least one instruction (1) was provided by the customer and (2) is received prior to a first delivery attempt of the item;
updating, via the carrier system, the shipping data to reflect the at least one instruction; and
transmitting, via the carrier system to a mobile station, at least a portion of the updated shipping data corresponding to the item, the updated shipping data comprising the at least one instruction; and
receiving, via the mobile station, at least a portion of the updated shipping data corresponding to the item, wherein (1) the mobile station is operated by a delivery person of the carrier, and (2) the item is subsequently delivered by the delivery person in accordance with the at least one instruction.

2. The method of claim 1 further comprising causing display, via the mobile station, of the at least a portion of the updated shipping data.

3. The method of claim 1 further comprising:
storing communication preferences for providing information regarding the item, wherein the communication preferences (1) identify at least one communication format and at least one corresponding electronic destination address to be used in providing the information to the customer, and (2) define a time period prior to the first delivery attempt of the item in which a message providing the information is to be transmitted to the at least one corresponding electronic destination address;
automatically generating a message providing the information regarding the item to be delivered to the customer; and
automatically transmitting the message to the at least one corresponding electronic destination address within the defined time period prior to the first delivery attempt of the item to the customer.

4. The method of claim 3, wherein the at least one communication format is selected from the group consisting of a text message, an email message, and a voice message.

5. The method of claim 3, wherein the at least one instruction identifies a location at the delivery address at which the item should be left.

6. The method of claim 1, wherein the at least one instruction identifies a code to input for entering an area proximate the delivery address.

7. A system for providing at least one instruction for delivering at least one item to a customer, the system comprising (1) a carrier system comprising one or more processors and one or more memory storage areas and (2) a mobile station comprising one or more processors and one or more memory storage areas:
wherein the carrier system is configured:
store shipping data corresponding to an item to be delivered to a customer by a carrier,
receive at least one instruction for delivering the item, wherein the at least one instruction (1) was provided by the customer and (2) is received prior to a first delivery attempt of the item,
update the shipping data to reflect the at least one instruction, and
transmit at least a portion of the updated shipping data corresponding to the item, the updated shipping data comprising the at least one instruction, and
wherein the mobile station is configured to receive at least a portion of the updated shipping data corresponding to the item, and wherein (1) the mobile station is operated by a delivery person of the carrier, and (2) the item is subsequently delivered by the delivery person in accordance with the at least one instruction.

8. The system of claim 7 wherein the mobile station is further configured to cause display of the at least a portion of the updated shipping data.

9. The system of claim 7 wherein the carrier system is further configured to:
store communication preferences for providing information regarding the item, wherein the communication preferences (1) identify at least one communication format and at least one corresponding electronic destination address to be used in providing the information to the customer, and (2) define a time period prior to the first delivery attempt of the item in which a message providing the information is to be transmitted to the at least one corresponding electronic destination address;
automatically generate a message providing the information regarding the item to be delivered to the customer; and
automatically transmit the message to the at least one corresponding electronic destination address within the defined time period prior to the first delivery attempt of the item to the customer.

10. The system of claim 9, wherein the at least one communication format is selected from the group consisting of a text message, an email message, and a voice message.

11. The system of claim 9, wherein the at least one instruction identifies a location at the delivery address at which the item should be left.

12. The system of claim 7, wherein the at least one instruction identifies a code to input for entering an area proximate the delivery address.
